(19) United States
(12) Patent Application Publication
(10) Pub. No.: US 2014/0121968 A1
(43) Pub. Date: May 1, 2014

(54) TECHNIQUE FOR THE ACOUSTIC SIGNALLING OF A NAVIGATION MANOEUVRE

(71) Applicant: ELEKTROBIT AUTOMOTIVE GmbH, ERLANGEN (DE)

(72) Inventor: Heinz Grotter, Nuernberg (DE)

(73) Assignee: ELEKTROBIT AUTOMOTIVE GmbH, ERLANGEN (DE)

(21) Appl. No.: 14/065,148

(22) Filed: Oct. 28, 2013

(30) Foreign Application Priority Data
Oct. 30, 2012 (DE) 10 2012 021 431.6

(51) Int. Cl. G01C 21/36

(52) U.S. Cl. CPC G01C 21/3629
USPC 701/540; 701/400

(57) ABSTRACT

A technique for the acoustic signalling of a navigation manoeuvre is described. A method aspect of this technique comprises providing an association between two or more navigation manoeuvres on the one hand and two or more manoeuvring instructions on the other hand. In this case, different nonverbal acoustic manoeuvring instructions are associated with different navigation manoeuvres. A navigation manoeuvre is signalled by outputting the nonverbal acoustic manoeuvring instruction associated with the navigation manoeuvre. This manoeuvring instruction may be a tone or a tone sequence.

### TECHNICAL FIELD

The present disclosure relates generally to the technical field of navigation. To be more precise, a technique for acoustically signalling a navigation manoeuvre is specified. The technique can be implemented in the form of a method, a computer program, a data collection or a navigation device.

### BACKGROUND

With the introduction of electronic driver assistance systems into automotive engineering, driving safety has increased dramatically in recent decades. Such assistance systems also include navigation devices which signal imminent navigation manoeuvres by outputting manoeuvring instructions. Owing to this signalling, the awkward fiddling with road maps by the driver while driving is no longer necessary. Instead, the driver can concentrate better on the traffic and thus recognise dangerous situations more quickly.

The signalling of navigation manoeuvres is usually carried out visually and acoustically. For acoustic signalling of navigation manoeuvres, verbal, i.e. spoken, manoeuvring instructions are output by the navigation device. A typical verbal manoeuvring instruction is, for example, the sentence “At the next junction, turn right onto Station Road”. The generation of such verbal manoeuvring instructions is done by means of so-called Text-To-Speech (TTS) technologies in modern navigation devices.

It has turned out that verbal manoeuvring instructions can become very long. Moreover, the manoeuvring instructions generated by means of TTS technologies are in some cases difficult to understand, especially when unusual place or street names are converted into speech. Since the processing of speech in the brain requires an increased effort, verbal manoeuvring instructions may therefore distract the driver from steering the motor vehicle. Such a distraction is, however, undesired precisely when a complex navigation manoeuvre is imminent, i.e. for example in the case of a turning procedure on a multilane roundabout. The speech output may also be a disturbance in other situations, for instance during a telephone call via handsfree equipment.

Of course, the speech output can be switched off in many navigation devices; the driver can then navigate using visual manoeuvring instructions such as arrow representations on a screen: however, it is precisely visual manoeuvring instructions that distract the driver, since the driver has to look away from the traffic.

To increase the driving safety in conjunction with the output of verbal manoeuvring instructions, various approaches have been pursued. In DE 10 2008 002 718 A1 it is proposed to output a tone or a tone sequence for an imminent navigation manoeuvre, in order to indicate to the driver that a verbal manoeuvring instruction is ready for output. If the driver subsequently actuates a key of the navigation device, the verbal manoeuvring instruction is output, otherwise this output does not occur.

### SUMMARY

A technique for the acoustic signalling of navigation manoeuvres is to be specified, which causes little distraction to the driver and in which the signalled navigation manoeuvres nevertheless are meaningful to the driver.

According to one aspect, a method for the acoustic signalling of a navigation manoeuvre is specified. The method comprises the step of providing an association between two or more navigation manoeuvres and two or more manoeuvring instructions, different nonverbal acoustic manoeuvring instructions being associated with different navigation manoeuvres, and the step of signalling a navigation manoeuvre by outputting the nonverbal manoeuvring instruction associated with the navigation manoeuvre.

According to one implementation, the nonverbal acoustic manoeuvring instructions each comprise at least one tone or at least one tone sequence (including sounds and jingles). In this way, different tones and/or different tone sequences can be associated with different navigation manoeuvres. The nonverbal acoustic manoeuvring instructions can in this case differ with regard to the respective tone pitch and/or with regard to the respective sequence of tones. Different tone sequences can differ with regard to the number of respectively included individual tones (with optionally the same tone pitch). Additionally or alternatively to this, different tone sequences can differ with regard to the tone pitches of at least two individual tones (with optionally the same number of individual tones). A tone sequence can also comprise a continuous change of tone pitch.

The nonverbal acoustic manoeuvring instructions can each have a length of less than approximately 3 seconds (e.g. less than approximately 2 seconds or less than approximately 1 second). According to a variant, some or all of the nonverbal acoustic manoeuvring instructions have a length of a few tenths of seconds. Accordingly, a tone used as a manoeuvring instruction or, in the case of the use of a tone sequence, an individual tone included therein can have a length of a few tenths of seconds.

In dependence on a distance or duration between two successive navigation manoeuvres, the nonverbal acoustic manoeuvring instructions associated with the two navigation manoeuvres can be output one after the other. For example, these manoeuvring instructions can be output one after the other before a first of the two navigation manoeuvres is performed. For the distance or duration it is in this case possible to preset a threshold value, on falling below which an output of the two nonverbal acoustic manoeuvring instructions one after the other takes place.

The navigation manoeuvres can be any manoeuvre which can be signalled by means of a manoeuvring instruction. The navigation manoeuvres with which different nonverbal acoustic manoeuvring instructions are associated can thus comprise at least a left turn and a right turn. For the left turn it is possible, for example, to provide a first tone or a first tone sequence, while for the right turn a different second tone or a different second tone sequence is provided. Further navigation manoeuvres for which different nonverbal acoustic manoeuvring instructions can be provided comprise one or more of the following manoeuvres: reduce speed, drive straight ahead, destination reached, keep right when there is more than one lane, keep left when there is more than one lane, and leave motorway.

Furthermore, different verbal acoustic (e.g. speech-based) and/or different graphical (e.g. pictogrammatic) manoeuvring instructions can be associated with different navigation manoeuvres. A specific navigation manoeuvre can in this case be additionally signalled by outputting the verbal acoustic and/or graphical manoeuvring instruction(s) associated with the navigation manoeuvre. In this case, the signalling of the nonverbal acoustic manoeuvring instruction can precede or else follow the signalling of the verbal acoustic manoeuvring instruction. Furthermore, it would be conceivable to output the nonverbal acoustic manoeuvring instruction during the reproduction of the verbal acoustic manoeuvring instruction.

The output, jointly but optionally offset in time, of a nonverbal acoustic manoeuvring instruction and of an associated verbal acoustic manoeuvring instruction is useful especially during a learning phase, in order to teach the driver the meaning of the nonverbal acoustic manoeuvring instruction. After completion of the learning phase, it is then possible merely to output the nonverbal acoustic manoeuvring instruction. This learning phase is also expedient when the verbal acoustic manoeuvring instructions are available in different languages, since the learning phase can in this case be carried out in the different languages.

The verbal acoustic manoeuvring instructions can be provided as previously recorded speech elements (e.g. speech segments or speech building blocks). It would, however, also be conceivable to resort to TTS technologies for this.

The outputting of a nonverbal acoustic manoeuvring instruction can take place during a telephone call via handsfree equipment. On the other hand, the outputting of a verbal acoustic manoeuvring instruction can be suppressed during the telephone call, so as to disturb the telephone call as little as possible.

Two or more different nonverbal acoustic manoeuvring instructions can also associated with a specific navigation manoeuvre. These instructions can then be output in dependence on a distance or duration until the navigation manoeuvre is performed. If, for example, a specific tone is associated with a specific navigation manoeuvre, this tone can be output once at a first distance or first duration before the navigation manoeuvre, and twice in succession at a shorter second distance or second duration before the navigation manoeuvre. Correspondingly, the volume of one and the same nonverbal acoustic manoeuvring instruction could also be varied in dependence on the distance or duration until the navigation manoeuvre is performed.

The method presented here can be performed in the course of a navigation procedure for a vehicle (e.g. for a motor vehicle or bicycle) or else a pedestrian. In this case, the nonverbal acoustic manoeuvring instruction can be signalled to a driver of the vehicle, i.e. for example inside a motor vehicle. Additionally or alternatively to this, it would be conceivable to signal the nonverbal acoustic manoeuvring instruction to an environment of the vehicle. Such a procedure is useful in particular in the case of electric vehicles, which because of the low noise generation are frequently not heard—and thus also not seen—for example by pedestrians.

According to a further aspect, there is provided a computer program product having program code means for performing the method presented here when the computer program product is executed on one or more computers. The computer program product can be stored on a computer-readable data carrier, for example a CD-ROM, a DVD-ROM or a semiconductor memory. Furthermore, the computer program product can be provided for downloading via a network.

A further aspect relates to a data collection comprising first data records which each define a navigation manoeuvre, and second data records which each define a nonverbal acoustic manoeuvring instruction, at least one second data record being associated with each first data record in the data collection in such a manner that different nonverbal acoustic manoeuvring instructions are associated with different navigation manoeuvres.

The data collection can be in the form of a file and/or in the form of a database. The database can be a navigation database for a navigation device. In other words, map data can also be stored in the database.

Furthermore, a navigation device is specified which comprises the said data collection and a device for the acoustic signalling of a navigation manoeuvre by outputting the nonverbal acoustic manoeuvring instruction associated with the navigation manoeuvre. The navigation device can be a portable device or else be fixedly installed in a motor vehicle. Accordingly, a motor vehicle comprising the navigation device is also provided.

### BRIEF DESCRIPTION OF THE DRAWINGS

Further aspects, advantages and backgrounds of the technique presented here for the acoustic signalling of a navigation manoeuvre will emerge from the following description of embodiments as well as from the figures, in which:

FIG. 1 shows an embodiment of a navigation device;

FIG. 2 shows a flow diagram illustrating an embodiment of a method aspect;

FIG. 3 shows an embodiment of an association between navigation manoeuvres and nonverbal acoustic manoeuvring instructions for a data collection;

FIGS. 4A to 4C show two embodiments for signalling nonverbal acoustic manoeuvring instructions in dependence on the distance or duration between two successive navigation manoeuvres; and

FIGS. 5A and 5B show two embodiments for signalling nonverbal acoustic manoeuvring instructions with respect to the output of a verbal acoustic manoeuvring instruction and with respect to the duration of a telephone call.

### DETAILED DESCRIPTION

In the following description of embodiments, various details of the technique presented here for the acoustic signalling of a navigation manoeuvre are explained. It will be understood that the embodiments described below can be modified in many different respects. For instance, it would be possible to implement the technique presented here in conjunction with other or additional navigation manoeuvres or else to use other manoeuvring instructions. Instead of the tones or tone sequences explained below, different noises or short speech fragments, for example, could also be used.

The following embodiments are explained mainly in conjunction with devices and methods. Of course, the technique presented here can also be implemented in conjunction with a programmed microprocessor, a digital signal processor (DSP) or specific circuits (e.g. ASICs).

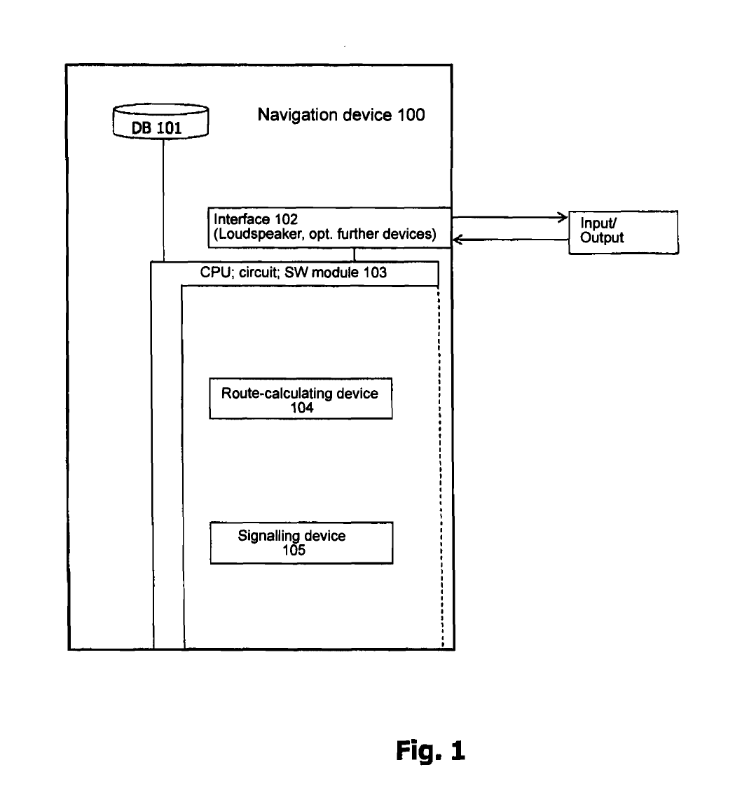

FIG. 1 illustrates an embodiment of a navigation device 100. The navigation device 100 can be a portable device or a device which is fixedly installed in a vehicle. The navigation device 100 comprises a database 101, an interface 102 and a core functionality 103.

In the embodiment, the database 101 is a navigation database which, besides conventional map data, also provides an association between two or more navigation manoeuvres on the one hand and two or more nonverbal acoustic manoeuvring instructions on the other hand. In the embodiment, the nonverbal acoustic manoeuvring instructions have no linguistic meaning and can therefore take the form of noises, short speech fragments, tones, etc.

Different navigation manoeuvres are associated with different nonverbal acoustic manoeuvring instructions in the database 101. This association (“coding”) can take place within an abstract table. Additionally, the navigation manoeuvres (e.g. in the form of codes, speech elements, pictograms, etc.) and/or the nonverbal acoustic manoeuvring instructions (e.g. in the form of sound files) can be stored in the database 101.

While the database 101 in the embodiment according to FIG. 1 forms an integral part of the navigation device 100, in other embodiments it would be conceivable to provide the database 101 at least in parts on a central server. The navigation device 100 can in this case be designed to access the database 101 via a communication connection (e.g. a mobile network).

The interface 102 is configured as a user interface and enables the input of data by a user and the output of data to the user. In the present embodiment, the interface 102 comprises a loudspeaker for the output of nonverbal acoustic manoeuvring instructions. In addition to this, the interface 102 can comprise a conventional or touch-sensitive screen (touchscreen) and one or more keys (e.g. a keypad).

The core functionality 103 is typically a microprocessor (Central Processing Unit, CPU), a circuit and/or a software module. In an implementation as a software module, the core functionality 103 can be stored in a memory of the navigation device 100 (not shown), in order to be executed by a CPU.

As illustrated in FIG. 1, the core functionality 103 comprises a route-calculating device 104 and a signalling device 105. The two devices 104, 105 can each take the form of a software module and have at least reading access to the database 101.

The route-calculating device 104 enables the calculation of a route from a starting point to a destination point via optional intermediate points using the map data of the database 101. The starting point can be determined by means of a position sensor (not illustrated) of the navigation device 100. The destination point and possible intermediate points can be based on a user input (using the interface 102).

The signalling device 105 is designed to perform, by output of manoeuvring instructions via the interface 102, a route guidance for the route determined by the route-calculating device 104. In the present embodiment, this route guidance comprises the signalling of navigation manoeuvres by outputting nonverbal acoustic manoeuvring instructions associated with the navigation manoeuvres. In addition to the nonverbal acoustic manoeuvring instructions, it is also possible to output verbal acoustic manoeuvring instructions and/or graphical manoeuvring instructions via the interface 102.

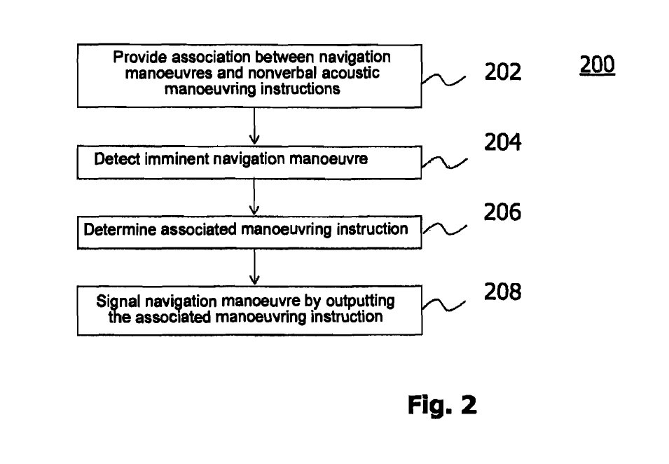

The functioning of the navigation device 100 will now be explained in more detail with reference to the flow diagram 200 according to FIG. 2. The steps shown in FIG. 2 proceed under control by the core functionality 103 according to FIG. 1.

In a first step 202, an association between navigation manoeuvres on the one hand and nonverbal acoustic manoeuvring instructions on the other hand is provided. As already explained, this association is stored in the database 101.

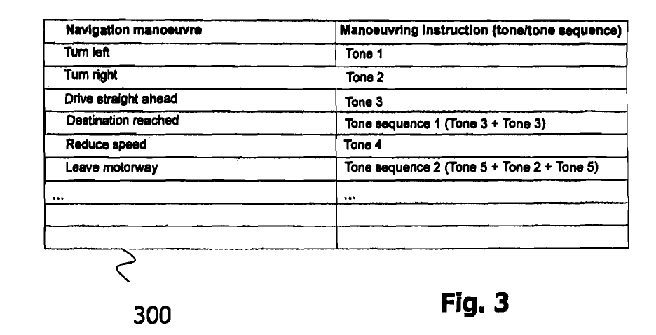

FIG. 3 shows, in an exemplary tabular form, how such an association 300 may appear. Thus, in the left-hand column the table references a multiplicity of first data records which each define a navigation manoeuvre. The first data records can be, for example, in text form (for output on a screen and for optional output as previously recorded speech elements or by means of TTS technologies), in graphical form (e.g. as pictograms for output on a screen) or in some other form (e.g. as codes). Furthermore, in the right-hand column the table references a plurality of second data records which each define or contain a nonverbal acoustic manoeuvring instruction. The second data records can be in a format such as that also used for storing music (e.g. in a WAV, MP3 or AAC format).

In the embodiment according to FIG. 3, each first data record is associated one-to-one with exactly one second data record. It would, however, also be conceivable for each first data record to be associated with two or more (optionally different) second data records. Furthermore, each second data record can be respectively associated with only exactly one first data record (e.g. in order to avoid confusion due to multiple use in different combinations). It would further be conceivable for a specific second data record to be associated with two or more first data records which are similar in terms of meaning (e.g. for the navigation manoeuvres “turn left” and “turn sharp left”).

Overall, the association between first data records and second data records occurs in such a way that different navigation manoeuvres (different first data records) are associated with different nonverbal acoustic manoeuvring instructions (different second data records or different combinations of second data records). Thus, for example, the navigation manoeuvre “turn left” is associated one-to-one with the tone 1, while the navigation manoeuvre “turn right” is associated one-to-one with the tone 2, which differs from the tone 1 (for example with regard to the tone pitch). The individual tones have a length of a few tenths of seconds.

The provision of the association 300, illustrated in FIG. 3, according to step 202 of the flow diagram 200 can take place offline, i.e. for example during the production of the navigation device 100. The remaining steps 204 to 208 are, by contrast, performed in real time during the operation of the navigation device 100. In this connection, first of all a route from a starting point to a destination point can be calculated by the route-calculating device 104. The steps 204 to 208 can then be performed in the course of the subsequent route guidance by the signalling device 105.

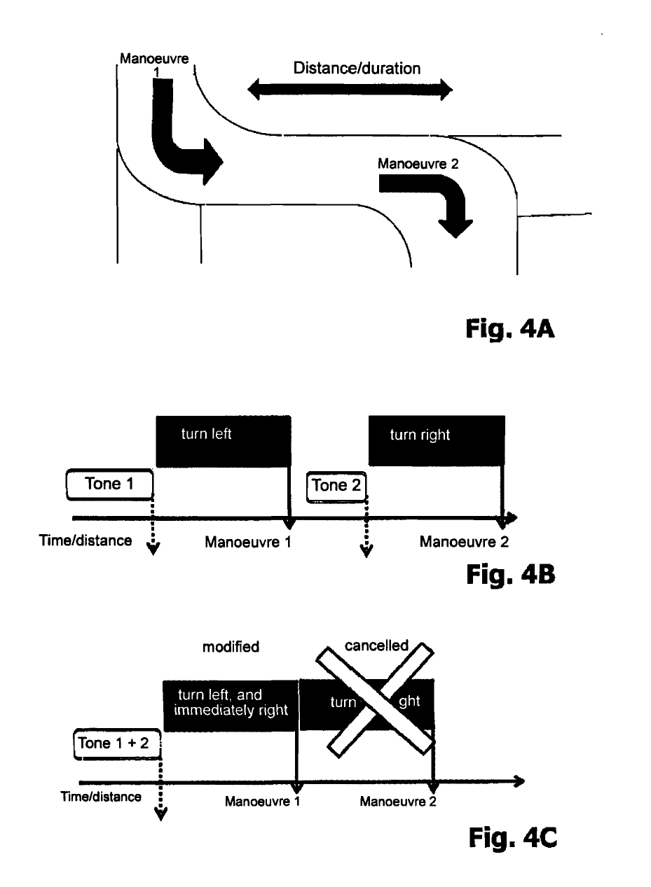

The steps 204 to 208 will now be explained in more detail with reference to the embodiments in FIGS. 4A to 4C. According to step 204, the signalling device 105 detects the imminence of a navigation manoeuvre during the route guidance. Thus, for example, by comparing the actual position with the calculated route, it can be detected that at a distance of 500 m or in 30 seconds it is necessary to turn left at a junction (cf. manoeuvre 1 in FIG. 4A). On falling below a distance threshold value or a time threshold value with respect to the imminent navigation manoeuvre, step 204 can therefore be performed.

When the falling below the threshold value is detected in step 204, in the following step 206 the type of navigation manoeuvre (“turn left”) is identified and the manoeuvring instruction associated with this type of navigation manoeuvre is determined. In this connection, the table according to FIG. 3 is accessed in order to determine that the tone 1 as the manoeuvring instruction is associated with the navigation manoeuvre “turn left”.

In a further step 208, the corresponding file for tone 1 is loaded from the database 101 and, on falling below a further distance threshold value or time threshold value with respect to the imminent navigation manoeuvre, is output. Thus, the tone 1 can be output, for example, when the distance to the imminent navigation manoeuvre is less than 50 m or the corresponding navigation manoeuvre is to be performed in less than 10 seconds (cf. manoeuvre 1 in FIG. 4B).

The steps 204 to 208 are then correspondingly repeated in the case of a following manoeuvre 2, as illustrated in FIGS. 4A and 4B. If, therefore, it is necessary to turn right at the next junction, as illustrated in FIG. 4A, the associated sound 2 is subsequently output as the manoeuvring instruction, as illustrated in FIG. 4B.

As illustrated in FIG. 4B, both for the manoeuvre 1 and for the manoeuvre 2, subsequent to the output of the tone 1 and of the tone 2 (as a nonverbal acoustic manoeuvring instruction), the respectively following output of the associated verbal acoustic manoeuvring instruction “turn left” and “turn right” takes place. The output of the verbal acoustic manoeuvring instruction can be switched off automatically or by the driver after a certain learning phase.

An exceptional situation may arise when the distance or duration between two successive navigation manoeuvres is very short, i.e. for example falls below a distance threshold value (of e.g. 25 m) or a time threshold value (of e.g. 5 seconds). In such a case, the conventional signalling by means of verbal acoustic manoeuvring instructions reaches its limits. The duration between the two manoeuvres is then too short to be able to output the verbal acoustic manoeuvring instruction for the second manoeuvre actually between the two manoeuvres. Admittedly, it would be conceivable to output both manoeuvring instructions before the first manoeuvre (e.g. in the form of “now turn left and after that immediately turn right”). However, in this case, complex manoeuvring instructions arise which cannot always be cognitively understood by the driver.

In order not to distract the driver unnecessarily in such a situation either, it is proposed, in dependence on a distance or duration between two successive navigation manoeuvres, to output the nonverbal acoustic manoeuvring instructions associated with the two navigation manoeuvres one after the other (and before the first navigation manoeuvre is performed). For this purpose, in the embodiment according to FIGS. 4A and 4C, the distance or duration between manoeuvre 1 and manoeuvre 2 can be subjected to a threshold value decision. If the distance or duration falls below the threshold value, the tones 1 and 2 associated with the manoeuvre 1 and the manoeuvre 2 are output immediately after one another, and before the manoeuvre 1 is performed (cf. FIG. 4C).

As shown in FIG. 4C, the output of the verbal acoustic manoeuvring instruction for the manoeuvre 2 is cancelled. The verbal acoustic manoeuvring instruction for the manoeuvre 1, by contrast, is modified or supplemented as compared with the scenario according to FIG. 4B and in the embodiment reads “turn left, and immediately right”. The output of the modified verbal acoustic manoeuvring instruction takes place immediately following the output of the tones 1 and 2.

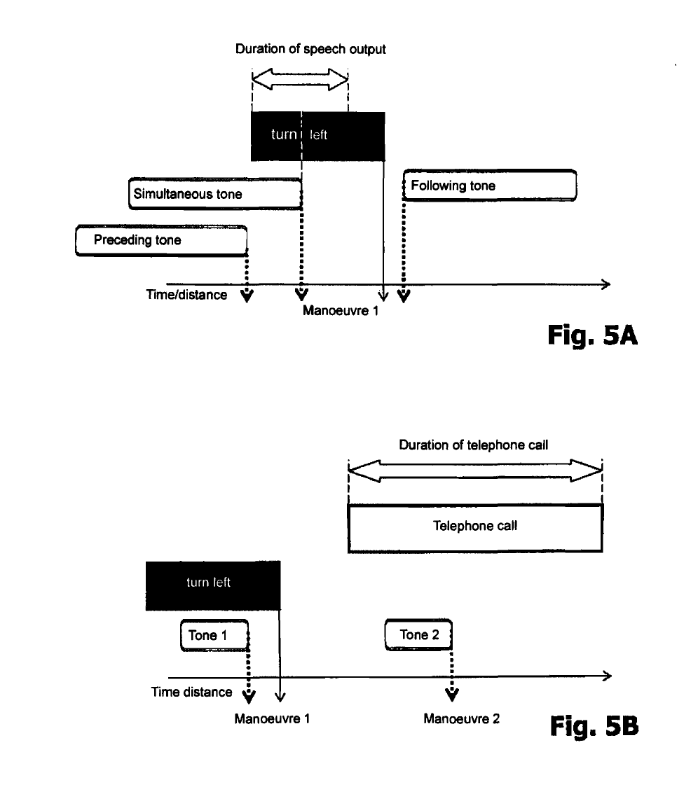

As illustrated in FIG. 5A, the output of the nonverbal acoustic manoeuvring instruction does not necessarily have to precede the output of the verbal acoustic manoeuvring instruction (speech output). Rather, the output of the nonverbal acoustic manoeuvring instruction can also take place during the duration of the output of the verbal acoustic manoeuvring instruction. Alternatively to this, it would also be conceivable to output the nonverbal acoustic manoeuvring instruction subsequent to the output of the verbal acoustic manoeuvring instruction.

In the case of conventional navigation devices, during telephone calls via handsfree equipment, acoustic manoeuvring instructions are often suppressed or merged into the telephone call at lower volume. According to the technique presented here, it is possible, for example, to output merely a short tone (optionally also at increased volume) which is easily perceptible by the driver and yet does not have a disturbing effect. In the case of high-quality motor vehicle sound systems, the tone could also be merged in at reduced or at increased volume.

FIG. 5B illustrates for the manoeuvring combination according to FIGS. 4A and 4B the suppression of the output of the verbal acoustic manoeuvring instruction for the manoeuvre 2 owing to a telephone call in progress. The nonverbal acoustic manoeuvring instruction associated with the manoeuvre 2 is, by contrast, output despite the telephone call in progress.

According to one implementation, the signalling of nonverbal acoustic manoeuvring instructions can be switched off. Additionally or alternatively to this, their reproduction volume may be adjustable. Furthermore, provision may be made for the association between navigation manoeuvres and nonverbal acoustic manoeuvring instructions to be performed or at least changed by the user himself. The user may also be permitted to generate or define the nonverbal acoustic manoeuvring instructions himself.

It is often advantageous if a nonverbal acoustic manoeuvring instruction is output additionally (e.g. before a) verbal acoustic manoeuvring instruction. The nonverbal acoustic manoeuvring instructions can thus be learnt quickly and simply. After only a few journeys the driver is aware of which nonverbal acoustic manoeuvring instruction is associated with which navigation manoeuvre. In addition, the different nonverbal acoustic manoeuvring instructions could be played back via a menu for learning purposes.

Further advantages of the technique presented here result from the fact that the nonverbal acoustic manoeuvring instructions are language-independent. This fact is advantageous especially when, for example, a hired car is used abroad, the navigation device of which can only be operated in the national language or the language settings of which cannot be found in the menu. Here, by observing the visual manoeuvring instructions and the associated nonverbal acoustic manoeuvring instructions, the driver can learn the corresponding association in a simple manner.

The technique presented here can also be utilised as a warning for other road users outside the vehicle. This is useful particularly in the case of electric vehicles, which generally cannot be perceived from the engine noise, in contrast to diesel and petrol vehicles. The output of the nonverbal acoustic manoeuvring indications outside the vehicle therefore constitutes an additional safety measure. This safety measure is, of course, not limited to electric vehicles.

If the nonverbal acoustic manoeuvring instructions take the form of tones or tone sequences, the (individual) tones should maintain a certain minimum separation in the frequency, so that they are easily distinguishable from one another. The frequencies should be chosen such that they are audible also for persons with poorer hearing (loss of the low or high frequencies). In this case, frequencies lying as far apart as possible can be chosen, for example, for the manoeuvres “turn right” and “turn left”. Continuous tone pitch changes may also be employed (e.g. falling tone=“turn left”, rising tone=“turn right”).

As emerges from the above description of a few embodiments, a nonverbal acoustic manoeuvring instruction can be output in a much shorter time than any voice announcement (verbal acoustic manoeuvring instruction). Furthermore, the nonverbal acoustic manoeuvring instruction can be loud in every case (e.g. also during a telephone call via handsfree equipment), without being a disturbance. In this way, ambiguous or poorly understandable manoeuvring instructions can be avoided. Furthermore, manoeuvring instructions can be output during a telephone call without significantly disturbing or even interrupting the conversation. The coding of manoeuvring instructions in nonverbal acoustic units which is proposed here can be implemented in a simple manner in addition to conventional mechanisms for signalling navigation manoeuvres.

1. A method for the acoustic signalling of a navigation manoeuvre, comprising the steps:
providing an association (300) between two or more navigation manoeuvres and two or more manoeuvring instructions, different nonverbal acoustic manoeuvring instructions being associated with different navigation manoeuvres; and
signalling a navigation manoeuvre by outputting the nonverbal manoeuvring instruction associated with the navigation manoeuvre.

2. The method according to claim 1,
wherein the nonverbal acoustic manoeuvring instructions each comprise at least one tone or at least one tone sequence.

3. The method according to claim 2,
wherein the nonverbal acoustic manoeuvring instructions differ with regard to the respective tone pitch and/or with regard to the respective sequence of tones.

4. The method according to claim 1,
wherein the nonverbal acoustic manoeuvring instructions each have a length of less than approximately 3 s.

5. The method according to claim 1,
wherein, in dependence on a distance or duration between two successive navigation manoeuvres, the nonverbal acoustic manoeuvring instructions associated with the two navigation manoeuvres are output one after the other and before a first of the two navigation manoeuvres is performed.

6. The method according to claim 1,
wherein the navigation manoeuvres comprise at least a left turn and a right turn.

7. The method according to claim 6,
wherein the navigation manoeuvres further comprise at least one of the following manoeuvres:
reduce speed;
drive straight ahead;
destination reached;
keep right when there is more than one lane;
keep left when there is more than one lane; and
leave motorway.

8. The method according to claim 1,
wherein furthermore different verbal acoustic and/or graphical manoeuvring instructions are associated with the different navigation manoeuvres,
and wherein the navigation manoeuvre is additionally signalled by outputting the verbal acoustic and/or graphical manoeuvring instruction associated with the navigation manoeuvre.

9. The method according to claim 8,
wherein the outputting of the nonverbal acoustic manoeuvring instruction takes place before the outputting or during the outputting of the verbal acoustic manoeuvring instruction.

10. The method according to claim 8,
wherein the verbal acoustic manoeuvring instructions are provided as previously stored speech elements.

11. The method according to claim 1,
wherein the outputting of the nonverbal acoustic manoeuvring instruction takes place during a telephone call via handsfree equipment.

12. The method according to claim 1,
wherein two or more different nonverbal acoustic manoeuvring instructions are associated with a specific navigation manoeuvre, which instructions are output in dependence on a distance or duration until the navigation manoeuvre is performed.

13. The method according to claim 1,
wherein the method is performed in the course of a navigation procedure for a motor vehicle and wherein the nonverbal acoustic manoeuvring instruction is signalled to a driver and/or to an environment of the motor vehicle.

14. A computer program product having program code means for performing the method according to claim 1 when the computer program product is executed on one or more computers.

15. The computer program product according to claim 14, stored on a computer-readable data carrier.

16. A data collection (101) comprising first data records which each define a navigation manoeuvre, and second data records which each define a nonverbal acoustic manoeuvring instruction, at least one second data record being associated with each first data record in the data collection in such a manner that different nonverbal acoustic manoeuvring instructions are associated with different navigation manoeuvres.

17. A navigation device (100), comprising the data collection (101) according to claim 16 and a device (105) for the acoustic signalling of a navigation manoeuvre by outputting the nonverbal acoustic manoeuvring instruction associated with the navigation manoeuvre.

18. A motor vehicle, comprising the navigation device (100) according to claim 17.

19. The method according to claim 9,
wherein the verbal acoustic manoeuvring instructions are provided as previously stored speech elements.
